(19) United States
(12) Patent Application Publication
(10) Pub. No.: US 2026/0338097 A1
(43) Pub. Date: Oct. 29, 2026

(54) METHOD FOR MONITORING COMPONENTS OF A VEHICLE IN RELATION TO EXHAUST GAS EMISSIONS

(71) Applicant: Robert Bosch GmbH, Stuttgart (DE)

(72) Inventor: Holger Jessen, Ludwigsburg (DE)

(21) Appl. No.: 19/650,744

(22) Filed: Apr. 17, 2026

(30) Foreign Application Priority Data
Apr. 23, 2025 (DE) 10 2025 115 558.5

(51) Int. Cl. F01N 11/00; G01M 17/007; G07C 5/04

(52) U.S. Cl. CPC F01N 11/007; G01M 17/007; G07C 5/04

(57) ABSTRACT

A method for monitoring components of a vehicle in relation to exhaust gas emissions. The method includes: providing emission data that comprise information about a temporal progression of exhaust gas emissions of the vehicle; providing state data that include information about a temporal progression of each of a plurality of state indicators, wherein each of the plurality of state indicators in each case is an indicator for a state of a component of the vehicle; determining, based on the emission data and the state data, correlation information concerning a correlation between a change in the exhaust gas emission and a change in at least one of the state indicators; determining, based on the correlation information, repair information in relation to at least one of the plurality of components; and providing the repair information.

### CROSS REFERENCE

The present application claims the benefit under 35 U.S.C. § 119 of Germany Patent Application No. 10 2025 115 558.5 filed on Apr. 23, 2025, which is expressly incorporated herein by reference in its entirety.

### FIELD

The present disclosure relates to a method for monitoring components of a vehicle in relation to exhaust gas emissions, in particular regarding a need for repair, and to a computing unit and a computer program for the performance of the method.

### BACKGROUND INFORMATION

Vehicles, in particular those having an internal combustion engine, cause exhaust gases or exhaust gas emissions, in particular, e.g., nitrogen oxides. Within the framework of climate and environmental protection, it is provided to keep such exhaust gas emissions as low as possible.

### SUMMARY

According to the present disclosure, a method for monitoring components of a vehicle regarding exhaust gas emissions and a computing unit and a computer program for the performance of said method are disclosed. Advantageous embodiments are disclosed herein.

The present disclosure relates to exhaust gas emissions of a vehicle and to monitoring components of the vehicle that are involved in the exhaust gas emissions. In particular, it also relates to recognizing whether a component is in need of repair.

For this purpose, a diagnosis can be provided. Diagnostic systems can be provided in control units of the vehicle, in particular with a significant number of diagnoses, with the aid of which, defects of the system or of the component can be recognized and indicated, generally including information about the cause of the fault. A basic concept of the indication of the fault information is in that the fault can be remedied or is then also remedied by a repair, typically by replacement of the affected component or subcomponent (for example, a sensor or actuator or a subsystem).

The recognition and indication (e.g., by warning lamp) of faults relevant to exhaust gas or emissions is compulsory, inter alia, for vehicles which have an internal combustion engine in the applicable legislation in each case as so-called “on-board diagnosis,” abbreviated as OBD, provided that, for example, a fault leads to an increase in emissions that exceeds a defined threshold. In particular, the information about the cause of the fault can be defined in standardized form by means of a standardized interface, so that effective and cost-efficient repair for the operator of the vehicle can be ensured. Remedying a fault indicated in such a way is generally compulsory, and the operation of defective vehicles can be prohibited by measures (e.g., the requirement for regular technical monitoring).

The boundary conditions for remedying faults are repeatedly being redefined within the framework of greater climate and environmental protection, see, e.g., so-called “EU7 legislation.” In addition to already existing requirements of on-board diagnosis, it is provided there, e.g., to introduce new requirements under the generic term of on-board monitoring, abbreviated as OBM. A basic concept of on-board monitoring is that, independently of the recognition of defects defined within the framework of OBD (and generally already present), any exceedance of specified emission limit values is or must be recognized and indicated, and that remedying of the fault is intended to be or will be enforced, by suitable measures (in particular including the limitation of possible vehicle operation).

In this respect, this on-board monitoring departs from the basic idea of the component-fault-related diagnosis of OBD and is based solely on the increase in emissions observed for the overall vehicle. Effective recognition and remedying of the cause of the fault is still required here, and, if applicable, is even of greater importance due to a missing fault entry in the OBD.

For compliance with nitrogen oxide or NOx emissions, it can be provided, e.g., to use a nitrogen oxide sensor as an additional signal-generating component; one possible fault scenario here is the presence of a driver warning and a restriction of vehicle operation by the OBM system due to elevated nitrogen oxide emissions measured by the sensor. However, conventional OBD systems would frequently indicate no fault at all in such cases. The cause of this behavior can be the summation of the effects of aging or of defects of components of the vehicle that are not yet subject to indication in each case (in the sense of conventional OBD).

Thus, repair in the workshop would be necessary, but without the OBD system providing information concerning the causative component.

State indicators that are indicators for a state of a component of the vehicle can be used. A plurality of state indicators can be assigned to one component. In particular, however, a state indicator is specific to (only) one particular component. The state is in particular a so-called health state or “state of health,” abbreviated as SoH. Such state indicators or corresponding signals can, in principle, already be used within the framework of conventional OBD. The basic concept pursued is to make characteristic test variables calculated in OBD functions or derived therefrom available as so-called “state-of-health (SoH) indicators” for workshops or a cloud memory and, in particular also using methods of artificial intelligence, to draw conclusions, by evaluation thereof, about the repair approach having the highest probability of success.

The issue here is, in particular, that existing and tested OBD diagnoses generally make the diagnostic decision based on a threshold value comparison of a characteristic variable, and the expectation that a greater distance of the current value from the threshold correlates with a lower fault probability, whereas a proximity to the threshold value indicates damage or at least that a fault is to be expected (very soon).

A data evaluation can be carried out in particular in the so-called “cloud,” i.e., on a central computing system that is independent of a vehicle. There, available information can be linked to repair instructions, for example based on models or methods of artificial intelligence, or also based on a field analysis (e.g., an assessment of workshop cases) along with additional measurement signals originating from test procedures to be performed in the workshop.

A challenge here for the identification of the component to be repaired is in the suitable selection and evaluation of the available data in the sense of the state (SoH) of the components. For the selected signals (state indicators) normalization is then generally required, so that, based on a direct comparison, a recommended repair order (ranking) of the state indicators and thus ultimately of the components can be ascertained. The order here should ideally also take into account the emission influence, in particular the nitrogen oxide influence, of the defect.

The method within the framework of the present disclosure provides a simple approach for this based on the use of the exhaust gas emission values that have been detected, e.g., by means of a sensor, specifically, e.g., a nitrogen oxide sensor.

However, as has been shown, a problem of cloud-based methods having centralized evaluation of the data of a vehicle fleet is in the acquisition and availability of the data; a very large number of measurements is required in order to robustly model the relationships existing for the overall fleet.

In general, there is indeed the possibility of learning such a data model successively from observed field data; however, this means that the information necessary for repair over the entire vehicle fleet, in particular for defective vehicles in need of repair, will only become available at a significantly later point in time relative to start of production. This is because fault cases would first have to occur, which can then be used for modeling or training the model. Significant extents of data quantities having the informational content important for repair (e.g., how the vehicle behaves with a defective component) are only present once the defects have occurred in the field for a corresponding number of vehicles.

In contrast, the method according to the present disclosure makes possible a cloud-independent partial contribution to the solution (in any event in the above sense of the cloud-based solution) by evaluating, in particular exclusively evaluating, the individual vehicle data over time, i.e., the vehicle data of an individual vehicle (so-called “vehicle history”). In this respect, the evaluation itself can be carried out locally in the vehicle, but also externally, e.g., also in the so-called “cloud” (but based on data of an individual vehicle).

The evaluation and derivation of repair instructions for the vehicle can thus be carried out in the event of a defect, independently of the time of occurrence (relative to the service life of the vehicle fleet, the so-called “fleet age”) and independently of data of the other vehicles of the vehicle fleet.

A further challenge is in ascertaining quantitative information about the actual emission influence of the defect and of the repair of a component, since emission measurements for, e.g., nitrogen oxides are generally not possible in the workshop. The quantitative detection of the component defect would be possible by detecting the change in emissions after the repair has been performed compared to before the repair; however, this information is only present once the respective defects occur in the field. For obtaining this information at an early point in time, targeted trimming of components in an experimental fleet would be necessary, which is associated with considerable effort.

The method of the present disclosure avoids the stated problems by modeling the emission effect of the change in the state indicators (SoH), and estimating the emission improvement based on this model in the vehicle.

The approach according to the present disclosure pursues the concept of deriving, independently of data of the vehicle fleet and solely based on values (in particular measured values) of the individual vehicle history, in particular the measured nitrogen oxide emissions, a statement concerning the suitable order (ranking) of the repair measures and concerning their expected emission improvement, or at least obtaining a statement concerning whether one of plurality of components and/or which of the plurality of components is in need of repair. The proposed approach is based on relating changes in exhaust gas emission values to changes in the state indicators.

Emission data and state data are provided. The emission data comprise information about a temporal progression of exhaust gas emissions (i.e., in particular, specific values of the exhaust gas emissions) of the vehicle; the exhaust gas emissions or the values thereof can in particular be detected or have been detected by means of a sensor. The state data comprise information about a temporal progression of each of a plurality of state indicators (i.e., in particular, specific values of the state indicators); each of the plurality of state indicators is in each case an indicator for a state of a component of the vehicle. As already mentioned, a plurality of different state indicators can also be provided for the same component. State indicators can be adaptation values of mixture adaptation along with the deviation of the adaptation values from an expected linear relationship. Further indicators can be a control deviation or adaptation values of sensors, such as a mass air flow meter, or correction factors for the injected fuel quantity, with which a possible need for repair of the fuel components is intended to be recognized. A major influence on emissions is exerted, in particular in the gasoline system, by probes and catalyst(s), the degeneration of which is indicated by the corresponding OBD diagnostic criteria.

Based on the emission data and the state data, correlation information is then determined which relates to a correlation between a change in the exhaust gas emissions and a change in at least one of the state indicators. Based on the correlation information, repair information in relation to the at least one of the plurality of components is then determined, which repair information is then also provided, so that, e.g., an affected component can be repaired. The repair information can comprise whether one of the plurality of components and/or which of the plurality of components is in need of repair; likewise, a ranking of a need for repair of the plurality of components is also conceivable, i.e., information as to which component should be repaired next and which, if applicable, thereafter. Information in this regard is then provided.

Thus, the state indicators are evaluated with respect to their effect on the exhaust gas emission values. The state indicators (SoH) can in particular be internal signals of a control unit, which are, e.g., also used as conventional OBD signals. However, it should be mentioned here that not all state indicators used for conventional OBD must also be used within the framework of the proposed method. Likewise, within the framework of the proposed method, other state indicators that are not used, e.g., for conventional OBD, can also be taken into consideration.

In particular, two embodiments are taken into consideration here, which can be used separately but also together.

In one example embodiment, the correlation information comprises checking whether a change in the exhaust gas emissions occurs, within the framework of a specified criterion, simultaneously with a change in the at least one of the state indicators. In particular, only such a change that is greater than a specified minimum value is regarded as a change in the exhaust gas emissions (or in the values thereof). Thus, it should in particular be an abrupt change. This can apply, e.g., to mean values within a certain time window before and a certain time window after the change. This applies correspondingly to a change in the at least one of the state indicators (or in the values thereof).

That these changes occur simultaneously within the framework of a specified criterion includes in particular the case that the changes occur within a specified temporal interval from one another. This takes into account the fact that changes in the exhaust gas and the state indicators or the corresponding components may be reflected, if applicable, with a slight temporal delay, but nevertheless go back to the same cause.

The correlation (correlation information) provides a preferred computational approach for the information as to whether such a change occurs and, if so, for which state indicators this change occurs. This is because causality can be inferred from the simultaneity of the events (if applicable, by ensuring this through an appropriate selection of the state indicators).

In a further example embodiment, the correlation information comprises a model for the increase in emissions caused by the fault, which model is determined based on the emission data and the state data, in each case within a specified period. Here, the correlation model indicates a dependency of the exhaust gas emissions and the at least one of the state indicators, preferably all of the plurality of state indicators. The modeling can be carried out, e.g., via an online algorithm for adaptation of a linear model. Here, thus, the repair information is determined based on the correlation model. The specified period in particular comprises a specified duration up to a current point in time in each case; the current point in time in each case can correspond to a current calculation point in time or a current measurement point in time at which measured values were most recently received. The period thus moves along, so that older data are eventually no longer taken into account.

Thus, this type of evaluation is carried out in particular continuously over time during vehicle operation, in that adaptation is used to map the development of the exhaust gas emissions due to aging (and upon the occurrence of any fault) into a model. Both a continuous deterioration and an abruptly occurring defect lead to changes in state indicators and the exhaust gas emissions. In the case of the defect, state indicators and the exhaust gas emissions change abruptly, without intermediate values being observed. In the case of continuous aging, state indicators and the exhaust gas emissions increase (not necessarily linearly, but continuously).

Thus, in summary, in the two example embodiments, a gradual change in state indicators and the exhaust gas emissions can be expected with partial damage occurring (i.e., in particular defects without recognition of the cause of the fault by the OBD); here, it is possible that a simultaneous change in a plurality of state indicators takes place (according to the selection of the state indicators). With continuous aging, the assignment of the exhaust gas emission increase to state indicators may not be linked to the temporal relationship.

A computing unit according to the present disclosure, e.g., a control unit of a motor vehicle, or a computer, is configured, in particular programmatically, to perform a method according to the present disclosure.

Furthermore, the implementation of a method according to the present disclosure in the form of a computer program or computer program product having program code for performing all the method steps is advantageous because it is particularly low-cost, in particular if an executing control unit is also used for further tasks and is therefore present anyway. Finally, a machine-readable storage medium having a computer program as described above stored thereon is provided. Suitable storage media or data carriers for providing the computer program are, in particular, magnetic, optical, and electric storage media, such as hard disks, flash memory, EEPROMs, DVDs, and others. It is also possible to download a program via computer networks (Internet, intranet, etc.). Such a download can take place in a wired or wireless manner (e.g., via a WLAN network or a 3G, 4G, 5G or 6G connection, etc.).

Further advantages and embodiments of the present disclosure can be found in the description and the figures.

The present disclosure is illustrated schematically in the drawings on the basis of an exemplary embodiment and is described below with reference to the figures.

### BRIEF DESCRIPTION OF THE DRAWINGS

FIG. 1 schematically shows a vehicle in which a method according to the present disclosure can be performed.

FIGS. 2A and 2B schematically show a sequence of a method according to the present disclosure in a preferred example embodiment.

FIG. 3 schematically shows different progressions of pressures and further parameters in a fluid supply system for explaining different diagnostic results in a method according to the present disclosure in a preferred example embodiment.

FIGS. 4A and 4B schematically show a sequence of a method according to the present disclosure in a further preferred example embodiment.

### DETAILED DESCRIPTION OF EXAMPLE EMBODIMENTS

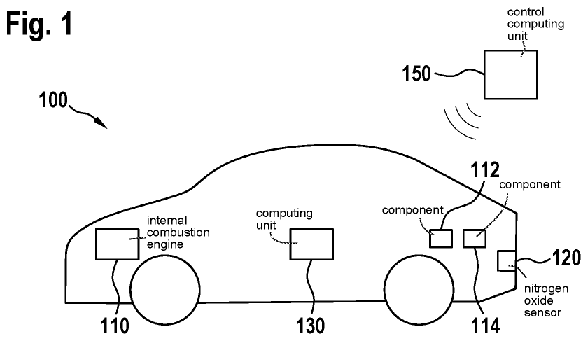

In FIG. 1, a vehicle 100 is schematically shown in which a method according to the present disclosure can be performed. The vehicle 100 has an internal combustion engine 110, and, by way of example, two components 112, 114, which, e.g., serve for exhaust gas aftertreatment or otherwise have an influence on the exhaust gas emissions of the vehicle 100. Furthermore, the vehicle 100 has a nitrogen oxide sensor 120, by means of which a nitrogen oxide emission, here as an example of exhaust gas emissions, can be measured.

In addition, the vehicle 100 has a computing unit 130 configured as a control unit, e.g., an engine control unit. The control unit can receive, e.g., measured values of the nitrogen oxide sensor 120, and likewise further measured or other data, based on which state indicators for the components 112, 114 can be determined or calculated.

In addition, a central computing unit 150 is shown by way of example, which can represent, e.g., the so-called “cloud.” The proposed method for monitoring components of the vehicle in relation to exhaust gas emissions can in particular be executed in the computing unit 130, but also on the central computing unit 150, which receives the relevant data, e.g., from the computing unit 130 via suitable data transmission. However, regardless of where the method or, specifically, the necessary calculations are performed, data relating to the individual vehicle 100 are used.

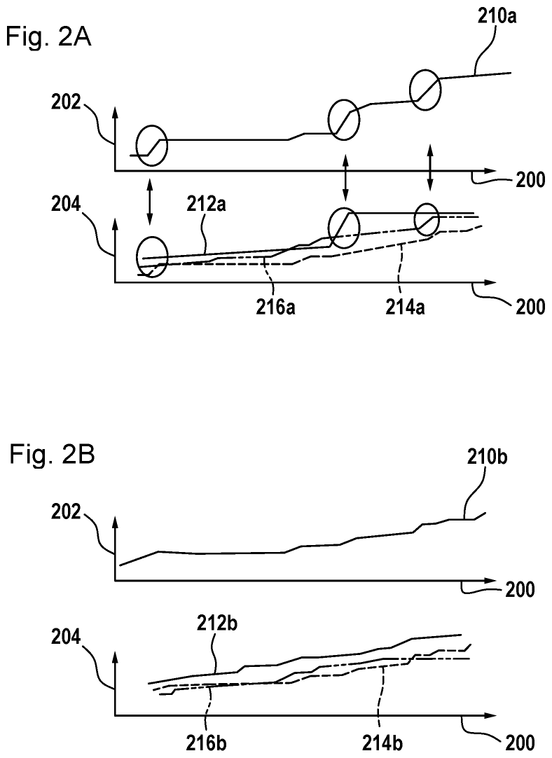

In FIG. 2A, 2B, diagrams are shown in which two different embodiments of a proposed method are explained. In both FIG. 2A, 2B, exhaust gas emissions 202 over time 200 are shown in an upper diagram, and state indicators 204 over time 200 are shown in a lower diagram.

Specifically, in the upper diagram of FIG. 2A, a temporal progression 210a of exhaust gas emissions is shown, and in the upper diagram of FIG. 2B, a temporal progression 210b of exhaust gas emissions is shown. These can specifically be nitrogen oxide emissions. In the lower diagram of FIG. 2A, temporal progressions 212a, 214a, 216a for three different state indicators are shown, and in the lower diagram of FIG. 2B, temporal progressions 212b, 214b, 216b for three different state indicators are shown.

It should be mentioned that the progressions shown in the relevant figure, i.e., exhaust gas emissions and state indicators, or the underlying values thereof, were in each case detected at the same point in time (or at least approximately the same point in time). A corresponding assignment can be carried out, e.g., via time stamps of the respective measured values.

These progressions or the underlying data can have been detected over an extended period. Since the vehicle generally also moves and thus covers a route, the temporal progression also correlates with a spatial progression.

The state indicators in both FIG. 2A, 2B can be the same; however, for purposes of explanation, they are data from different vehicles or different periods, which can also be seen from the slightly different specific progressions.

For monitoring components, emission data and state data are now provided in the two embodiments. The emission data comprise information about a temporal progression of exhaust gas emissions of the vehicle, as shown, e.g., in the upper diagrams of FIG. 2A, 2B. The state data comprise information about a temporal progression of each of a plurality of, e.g., three, state indicators, as shown, e.g., in the lower diagrams of FIG. 2A, 2B. In each case, each state indicator is an indicator for a state of a component of the vehicle.

Based on both FIG. 2A, 2B, the basic idea of the two embodiments is initially apparent. This can also be referred to as two paths for determining correlations. As already mentioned, the two embodiments or paths can also be used in parallel or together, which leads to better monitoring and ultimately the determination of any need for repair of components.

Based on the emission data and the state data, in the two embodiments, correlation information is determined concerning a correlation between a change in the exhaust gas emission and a change in at least one, but preferably all, of the state indicators.

In FIG. 2A, three locations are shown in the upper diagram, i.e., in the temporal progression 210a of the exhaust gas emissions, at which a significant change, i.e., an abrupt change in the progression, occurs. Each of these three changes temporally correlates with a change in one of the state indicators, as illustrated by double arrows. This shows the possibility of finding, through this type of analysis of the data, a relationship between the state indicators and the exhaust gas emissions and, in particular, identifying a specific state indicator, and thus a specific component, as causative and thus, if applicable, in need of repair.

In FIG. 2B, slight variations, but no significant changes, can be seen in the upper diagram, i.e., in the temporal progression 210b of the exhaust gas emissions. The same applies to the state indicators. Although this does not directly indicate causality of a state indicator or of the relevant component for changes in the exhaust gas emissions, certain relationships nevertheless exist, as can be seen based on the generally increasing progressions. Thus, an analysis can likewise be performed, as will be explained in greater detail below.

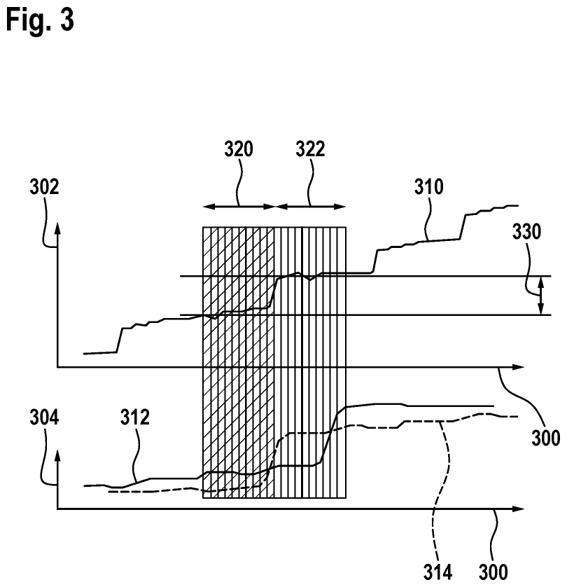

Based on FIG. 3, the embodiment or the path according to FIG. 2A will initially be explained in greater detail. Similarly to FIG. 2A, exhaust gas emissions 302 over time 300 are shown here in an upper diagram. In the lower diagram, temporal progressions 312, 314 for two different state indicators are shown.

A possible implementation of the basic idea of ascertaining the state-indicator contribution of partial component damage by evaluating exhaust gas emissions and state indicators is shown here. A simultaneous change can be ascertained by evaluating the mean value of the emission and state data or values of the trips before and after a significant change in the exhaust gas emissions. If the mean values of the two test measurement periods 320 and 322 differ significantly both for the exhaust gas emissions and for one state indicator, here state indicator 312, then a simultaneous change is recognized. The correlation is a preferred method for ascertaining the significant, common change of a state variable and the emissions, as already explained above in greater detail.

The change in the exhaust gas emissions is assigned in particular to the state indicator having the greatest change in the mean value. Alternatively, it can be stored, e.g., that a combination of changes is characteristic for a component, and the assignment of the change is carried out for this component. Alternatively to the change in the mean value of the exhaust gas emissions, the correlation of the sample values of the exhaust gas emissions and state indicators can be used as a criterion for the assignment. In the simplest case (and preferably), the values of the exhaust gas emissions and of the state indicator ascertained for the trip are to be used as sample values under suitable conditions.

Using the described procedure, an ongoing evaluation can be carried out over the sequence of trips as to whether a simultaneous change of exhaust gas emissions and of a state indicator is present (with a suitably selected quality criterion for simultaneous change, as already explained above in greater detail). In the given case, e.g., a delta portion 330 of the exhaust gas emissions is assigned to the state indicator or the identified component—as a summary contribution to the increase in exhaust gas emissions. In the simplest case, the assignment is carried out to the state indicator that has the greatest correlation (or, more generally, the greatest value of the quality criterion of the simultaneous change). In the more complex case, selection criteria composed of a plurality of quality criteria can also be defined, in particular if the change of a plurality of state indicators results from component damage.

A particular advantage of the evaluation according to this path is in that, in comparison with the absolute values of the state indicators, the additional information about the temporal relationships of the change in state indicator and exhaust gas emission is utilized. In distinction from and in addition to the approach of evaluating state indicators at the point in time of repair, the information of the change in exhaust gas emissions over time is evaluated. In contrast, models based on the state indicators at the point in time of repair only consider the final state of the state indicators, whereas the information from the temporal progression of the exhaust gas emission results of the trips, correlated with the state indicators (measured by the vehicle sensor), is neglected entirely.

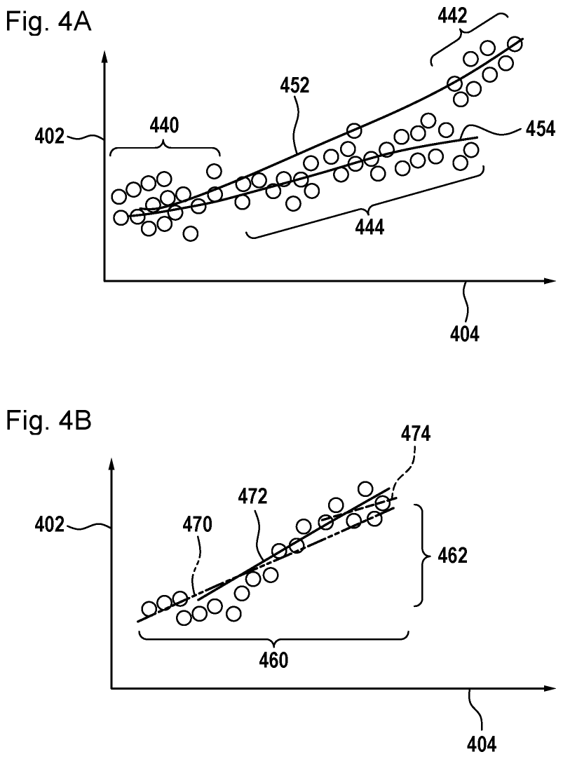

Based on FIG. 4A, 4B, the embodiment or the path according to FIG. 2B will now be explained in greater detail. Here, exhaust gas emissions 402 over a state indicator 404 are shown in each case in one diagram. Specific pairs of values (value pairs) of the exhaust gas emission and the state indicator that were detected at the same point in time (or at least approximately the same point in time) are shown with circles.

In this continuous path, the evaluation is carried out in particular continuously over time during vehicle operation, in that adaptation is used to map the development of the exhaust gas emissions due to aging (and upon the occurrence of a fault) into a model (a correlation model). Both a continuous deterioration and an abruptly occurring defect lead to changes in state indicators and the exhaust gas emissions. In the case of the defect, state indicators of the exhaust gas emissions change abruptly, without intermediate values being observed. In the case of continuous aging, state indicators and the exhaust gas emissions increase, not necessarily linearly but continuously.

This is shown in FIG. 4A. Value pairs in an earlier period are shown at 440, and value pairs in a later period are shown at 442, wherein state indicators of the exhaust gas emissions change abruptly. This indicates a defect. A model created based on these value pairs 440, 442 is designated by 452. At 444, value pairs of an alternative scenario having a continuous change are shown, wherein state indicators of the exhaust gas emissions change only slightly. This indicates continuous aging. A model created based on these value pairs 440, 444 is designated by 454.

In the two cases, the modeling of the exhaust gas emissions over the entirety of the state indicators in the course of vehicle operation provides the possibility of drawing, from the relevant dependency of the exhaust gas emissions on the state indicator, the conclusion as to the emission reduction achievable by repair. According to the extent to which the recent past is factored into the models (the so-called “forgetting factor”; referred to above as the “specified period”), the models take into account that, for an older vehicle, repairing a component is likely to result in only a partial reduction in emissions compared to a new vehicle. The model is thus a local approximation of the emission effect.

The model-based ascertained emission contributions of the respective state indicators can be interpreted directly as a ranking; i.e., information is available as to which state indicators can make which contribution to reducing the emissions.

An advantage of the proposed procedure is in that normalization of the input variables, the state indicators, is not required, i.e., no a priori knowledge is required about the relationship between the state indicators, which if applicable are still to be defined only in the course of development, and the exhaust gas emissions; in particular, it is not necessary to know the threshold of the state indicator at which the exhaust gas emissions exceed the OBM threshold.

When using the model, it can be assumed in a simple case that the state indicators are selected so that repair of a component can be inferred from the emission contribution ascertained for the state indicators. The selection will generally be based on expert knowledge; in addition, the information concerning the relationship between state indicators and component can be provided by a more complex model based on information about the vehicle fleet in the cloud. In particular, even with careful selection of the state indicators, if applicable, in individual cases, an influence of one component on a plurality of state indicators is unavoidable, and it may be necessary to map exhaust gas emissions ascertained for state indicators onto components by way of transformation (e.g., from fleet information).

As a simple method for modeling, a least-squares approach can be used, which can be implemented recursively in the sense of economical use of resources. Advantages of the recursive least-squares method are robustness, statistical interpretability and efficiency, also with respect to the requirements for the available data quantity. As an extension, nonlinear relationships can also be mapped by preceding linearization of the state indicators.

Possible ways for the modeling are to be explained below, specifically for the case of the discontinuous path, i.e., a change based on a defect, and for the case of the continuous path, i.e., a change based on aging.

In the discontinuous path, different approaches are possible for evaluating the temporally connected change of state indicators and exhaust gas emissions, which are based on the same core concept. By evaluation of ascertained state indicators and exhaust gas emissions before and after the assumed defect event (exhaust gas emission step), a quality criterion is formed, the value of which is a quantitative measure for the temporal convergence. In addition to the already mentioned approach of the correlation (cross-correlation) and the calculation by statistical test (one-sample test or two-sample test), in each case for exhaust gas emissions and state indicators, a simple probability-based approach can be used for the evaluation.

Here, e.g., the Pearson correlation r can be used with individual values i of the variables x (state indicators) and y (exhaust gas emissions), preferably one value per trip. n is the total number of the trips under consideration, and x and y marked by an overbar are the arithmetic mean values.

$${r}_{x y} = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

One possibility is a so-called “one-sample t-test” for calculating the empirical probability of a significant change (difference of the values before and after the defect event being unequal to zero). Alternatively to the one-sample t-test on difference values, the two-sample t-test on the values of two test sets can be used.

Likewise, e.g., a so-called “Yule coefficient” can be considered, in which the correlation between premise (change in state indicators) and conclusion (change in exhaust gas emissions) is determined.

In the continuous path, a basic approach can use the conventional recursive least-squares method (RLS method) for an online identification of the parameters of the linear model for formation of the state indicators. For the formation of the state indicators, the contribution of the relevant state indicator to the observed increase in emissions can be ascertained. The calculation sequence can specifically be as follows:

$$\underline{\hat{Θ}} ( k + 1 ) = \underline{\hat{Θ}} ( k ) + \frac{P ( k ) \cdot \underline{h} ( k + 1 )}{λ + {\underline{h}}^{T} ( k + 1 ) \cdot P ( k ) \cdot \underline{h} ( k + 1 )} \cdot ( y ( k + 1 ) - {\underline{h}}^{T} ( k + 1 ) \cdot \underline{\hat{Θ}} ( k ) )$$

$$P ( k + 1 ) = \frac{1}{λ} \cdot ( P ( k ) - \underline{γ} ( k + 1 ) \cdot {\underline{h}}^{T} ( k + 1 ) \cdot P ( k ) )$$

The calculation of the model output variable y from the inputs h and the parameter vector Θ is as follows:

\hat{y}(k)=h^{T}\hat{Θ}

This is the basic approach of the RLS method. The estimated value of the current emission value y, in the application case, the measured value of the exhaust gas emission, is ascertained as a weighted linear combination of the input variables, state indicators, vector h. The estimator of the vector Θ provides the current parameters for the weighting.

The online update is carried out by recalculation of the matrix P and of the vector Θ in each update step if new values of the state indicators are present. By specification of the forgetting factor λ, the higher weighting of the values of the state indicators from the more recent past is carried out. An advantage of the recursive method is in that a storage of large data quantities is not required and the computational effort remains constant over time.

In the proposed use of the RLS method for the task of supporting repair measures (so-called “pinpointing”), it can be provided that, with the values of the vector Θ, a contribution to the increase in emissions yi is calculated for each state indicator. For this purpose, the change of the state indicator relative to a reference value (non-defective vehicle) is multiplied, if applicable, proportionally, by the corresponding parameter of the vector θ. In the case of a linear change in the exhaust gas emissions according to changed state indicators, the sum of the contributions of yi would correspond to the total increase in the emissions. In the case of a nonlinear relationship between exhaust gas emission and state indicators, the calculated value yi can vary according to the forgetting factor. The forgetting factor controls, in the desired manner, the extent to which a past increase in the emissions simultaneous with an increase in a state indicator is still taken into account in the formation of the output variables yi.

This relationship is shown in FIG. 4B. For the shown pairs of values, from left, a known functional state, to right, a current state, a change of a state indicator (increase) is shown at 460, and an increase in emissions (change, yi) is shown at 462. Different models (here: lines) are shown at 470, 472, 474; depending on the forgetting factor from 470, via 472, to 474, the forgetting factor increases, which means that earlier value pairs are taken into account less and less.

What is claimed is:

1. A method for monitoring components of a vehicle in relation to exhaust gas emissions, comprising the following steps:
providing emission data that include information about a temporal progression of exhaust gas emissions of the vehicle;
providing state data that include information about a temporal progression of each of a plurality of state indicators, wherein each of the plurality of state indicators is an indicator for a state of a respective component of a plurality of the components of the vehicle;
determining, based on the emission data and the state data, correlation information concerning a correlation between a change in the exhaust gas emissions and a change in at least one of the state indicators;
determining, based on the correlation information, repair information in relation to at least one of the plurality of components; and
providing the repair information.

2. The method according to claim 1, wherein the determining of the correlation information includes:
checking whether a change in the exhaust gas emissions occurs, within a framework of a specified criterion, simultaneously with a change in the at least one of the state indicators,
wherein the correlation information includes information as to whether the change in the exhaust gas emissions occurs simultaneously with the change in the at least one of the state indicators, the correlation information including for which of the state indicators the change occurs.

3. The method according to claim 2, wherein the specified criterion includes that the change in the exhaust gas emissions and the change in the at least one of the state indicators occur within a specified temporal interval from one another.

4. The method according to claim 1, wherein the correlation information includes a correlation model that is determined based on the emission data and the state data, in each case within a specified period, wherein the correlation model indicates a dependency of the exhaust gas emissions and the at least one of the state indicators.

5. The method according to claim 4, wherein the specified period includes a specified duration up to a current point in time in each case.

6. The method according to claim 1, wherein the repair information in relation to the at least one of the plurality of components includes at least one of the following pieces of information:
information as to whether one of the plurality of components is in need of repair;
information as to which of the plurality of components is in need of repair;
information concerning a ranking of a need for repair of the plurality of components.

7. The method according to claim 1, wherein values of the exhaust gas emissions include nitrogen oxide emission values.

8. The method according to claim 1, wherein values of the exhaust gas emissions of the vehicle are detected using a sensor, wherein the sensor is arranged on or in the vehicle.

9. A computing unit configured to monitor components of a vehicle in relation to exhaust gas emissions, the computing unit configured to perform the following steps comprising:
providing emission data that include information about a temporal progression of exhaust gas emissions of the vehicle;
providing state data that include information about a temporal progression of each of a plurality of state indicators, wherein each of the plurality of state indicators is an indicator for a state of a respective component of a plurality of the components of the vehicle;
determining, based on the emission data and the state data, correlation information concerning a correlation between a change in the exhaust gas emissions and a change in at least one of the state indicators;
determining, based on the correlation information, repair information in relation to at least one of the plurality of components; and
providing the repair information.

10. A non-transitory machine-readable storage medium on which is stored a computer program monitoring components of a vehicle in relation to exhaust gas emissions, the computer program, when executed by a computer, causing the computer to perform the following steps:
providing emission data that include information about a temporal progression of exhaust gas emissions of the vehicle;
providing state data that include information about a temporal progression of each of a plurality of state indicators, wherein each of the plurality of state indicators is an indicator for a state of a respective component of a plurality of the components of the vehicle;
determining, based on the emission data and the state data, correlation information concerning a correlation between a change in the exhaust gas emissions and a change in at least one of the state indicators;
determining, based on the correlation information, repair information in relation to at least one of the plurality of components; and
providing the repair information.
